(19) United States
(12) Patent Application Publication
(10) Pub. No.: US 2024/0293859 A1
(43) Pub. Date: Sep. 5, 2024

(54) Modular Stretch Block Using Additive Manufacturing

(71) Applicant: Textron Aviation Inc., Wichita, KS (US)

(72) Inventors: Andrew Ricks, Wichita, KS (US); Joshua Workman, Rose Hill, KS (US); Bradley Randal Higgins, Wichita, KS (US); Royce Heick, Goddard, KS (US); Juan Manuel De La Rosa Valverde, Wichita, KS (US)

(21) Appl. No.: 18/594,192

(22) Filed: Mar. 4, 2024

Related U.S. Application Data
(60) Provisional application No. 63/488,218, filed on Mar. 3, 2023.

(51) Int. Cl. B21D 25/02; B33Y 80/00

(52) U.S. Cl. CPC B21D 25/02; B33Y 80/00

(57) ABSTRACT

An exchangeable forming component is configured for removable mounting relative to an interface block of a modular forming tool, with the interface block of the modular forming tool configured for removable mounting relative to a support structure to form a sheet metal component. The exchangeable forming component includes a component structure which is constructed using additive manufacturing, wherein the exchangeable forming component presents a first surface which provides an exchangeable forming surface shaped to form the sheet metal component, and a second surface configured to removably engage the support structure.

### CROSS-REFERENCE TO RELATED APPLICATIONS

This application claims the priority benefit of U.S. Provisional Application No. 63/488,218, filed Mar. 3, 2023, entitled MODULAR STRETCH BLOCK USING ADDITIVE MANUFACTURING, which is hereby incorporated in its entirety by reference herein.

### BACKGROUND OF THE INVENTION

### 1. Field

The disclosed embodiments relate generally to the field of aircraft manufacturing. More specifically, the disclosed embodiments relate to a novel method of sheet metal forming and sheet metal stretching, and the modular tooling required to perform such activities created using additive manufacturing techniques.

### 2. Description of the Related Art

Various stretch forming techniques have been described in the prior art. U.S. Pat. No. 7,568,371 to Polen et al. describes a forming machine known in the art, which pulls the edges of a sheet metal piece over a die to form a sheet metal component. U.S. Pat. No. 2,434,379 to Wiesner et al. describes a die whose surface is used to form a particular sheet metal component.

### SUMMARY

In an embodiment, a modular forming tool is configured for removable mounting relative to a support structure to form a sheet metal component. The modular forming tool broadly includes an exchangeable forming component which is constructed using additive manufacturing, wherein the exchangeable forming component presents a first surface which provides an exchangeable forming surface shaped to form the sheet metal component, and a second surface configured to removably engage the support structure and align the exchangeable forming surface relative to the support structure.

In another embodiment, an exchangeable forming component is configured for removable mounting relative to an interface block of a modular forming tool, with the interface block of the modular forming tool configured for removable mounting relative to a support structure to form a sheet metal component. The exchangeable forming component includes a component structure which is constructed using additive manufacturing, wherein the exchangeable forming component presents a first surface which provides an exchangeable forming surface shaped to form the sheet metal component, and a second surface configured to removably engage the support structure.

In another embodiment, a method of forming sheet metal components includes selecting a desired sheet metal component shape; using additive manufacturing techniques to construct an exchangeable forming component presenting a first surface shaped according to the desired sheet metal component shape; and stretch forming sheet metal over the first surface of the exchangeable forming component, such that one or more sheet metal components are formed in the desired sheet metal component shape.

This summary is provided to introduce a selection of concepts and preferred embodiments in a simplified form that are further described below in the detailed description. This summary is not intended to identify key features or essential features of the claimed subject matter, nor is it intended to be used to limit the scope of the claimed subject matter. Other aspects and advantages will be apparent from the following detailed description of the embodiments and the accompanying drawing figures.

### BRIEF DESCRIPTION OF THE SEVERAL VIEWS OF THE DRAWINGS

Illustrative embodiments are described in detail below with reference to the attached drawing figures, which are incorporated by reference herein and wherein:

FIG. 1 is a perspective view of a modular stretch block assembly in an embodiment;

FIG. 2 is a perspective view of the modular stretch block assembly, and the attachment bracket components according to embodiments;

FIG. 3A and FIG. 3B are side perspective views of the modular stretch block assembly from FIG. 1;

FIG. 4 is a detailed perspective view of the interface surface of the modular stretch block assembly from FIG. 1; and,

FIG. 5A and FIG. 5B are perspective break out views of a pneumatic prick punch system according to embodiments.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense. The scope of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc., described in one embodiment may also be included in other embodiments but is not necessarily included. Thus, the technology can include a variety of combinations and/or integrations of the embodiments described herein.

Traditional stretch blocks, also called form dies, are solid contoured pieces against which sheet metal will be pressed or pulled, to form the sheet metal into a metal component. The stretch block is typically used in a forming machine, which presses the stretch block into the secured sheet of metal, or alternatively holds the stretch block in place while pulling sheet metal over its top. Stretch forming can be used on a variety of materials, including, but not limited to, various forms of aluminum, steel, and titanium sheet metals. Traditional stretch blocks are made-to-order for producing a specific sheet metal component, they are commonly composed of heavy materials which are difficult to handle and are produced by tool and die makers using techniques such as metal casting, forging, and subtractive manufacturing. As they are made-to-order and labor intensive, stretch blocks are traditionally expensive and carry long lead times, which is a serious concern when mass-producing a large variety of components. Additionally, stretch blocks may fail or become damaged unexpectedly, which results in increased overhead cost and delays. These complications introduce monetary risk and unnecessary frustration for sheet metal component manufacturers.

Improved embodiments of stretch block systems, such as a modular stretch block system, may provide an exchangeable forming surface (EFS) for use in sheet metal stretch forming. Improved stretch block systems may be constructed with additive manufacturing (AM) techniques. Also, improved stretch block systems may be cheaper, faster, and more customizable than their traditional counterpart stretch blocks. In at least certain embodiments, a modular stretch block (MSB) system may include a universal interface block mounted on a baseplate. The baseplate may be designed to be affixed to the support structure of a forming machine, and with the EFS mounted relative to the interface block. Further still, what is needed is a method of forming sheet metal components using a MSB system, which comprises swapping the EFS for one of a plurality of EFSs which can be mounted to the interface block; each EFSs producing a different sheet metal component design.

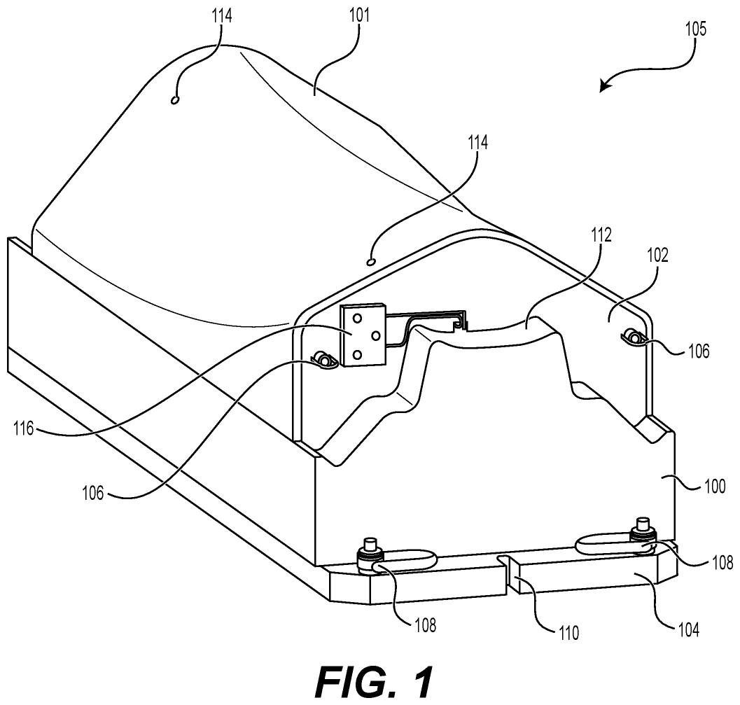

FIG. 1 shows a perspective view of an embodiment including an exchangeable forming block or exchangeable forming component 101 (hereinafter “exchangeable forming component 101”) that presents an exchangeable forming surface or EFS 102 (hereinafter “EFS 102”). EFS 102 of the exchangeable forming component 101 may comprise a 3D printed polymer. EFS 102 also may be shaped to form a sheet metal component (not shown) with a desired sheet metal component shape. That is, the EFS 102 may be shaped according to the desired sheet metal component shape.

Further, the exchangeable forming component 101 may be interchangeable with multiple additional forming components that are also exchangeable (such that the additional forming components may be interchangeably used with an interface block 100). The additional forming components may present respective EFSs that are shaped differently from one another and from EFS 102. As a result, the additional forming components and exchangeable forming component 101 may be shaped to form respective sheet metal components with corresponding desired sheet metal component shapes that are shaped differently from one another.

In other embodiments, exchangeable forming component may be produced using a variety of common AM techniques, including at least material extrusion (common form of 3D printing), sheet lamination, binder jetting, material jetting, directed energy deposition, powder bed fusion, and vat photopolymerization. In other embodiments, the exchangeable forming component may also be constructed out of other materials that can be used in AM, such as different forms of polymers, resins, ceramics, and powdered metals. Other AM techniques and associated construction materials can be readily implemented without diverging from the scope of the claimed invention.

The exchangeable forming component 101 may be removably affixed relative to the interface block 100 and a baseplate 104. The interface block 100, exchangeable forming component 101, and baseplate 104 may cooperatively provide a modular forming tool 105.

The interface block 100 may be removably supported on the baseplate 104. Interface block 100 may present a mating surface 107 that removably engages a mating surface 109 of the baseplate 104. The mating surfaces 107 and 109 may be complementally shaped. Although mating surfaces 107 and 109 may be planar, the mating surfaces may be alternatively shaped. The interface block 100 may be affixed on top of baseplate 104 by fasteners (not shown), pins (not shown), and/or other removable attachment elements. Interface block 100 may present an interface block mating surface 112 that extends along a longitudinal axis of symmetry. The interface block mating surface 112 may define the entire top surface of interface block 100. As will be described, the interface block mating surface 112 may define longitudinal securing elements configured to be received by the exchangeable forming component 101. Interface block 100 may be machined from a billet of aluminum. Baseplate 104 may be manufactured from steel. In various embodiments, other materials or manufacturing techniques may be used to produce the baseplate 104 and/or the interface block 100.

In the depicted embodiment, baseplate lifting hooks 108 may be attached relative to a top surface of baseplate 104. A mounting slot 110 exists on baseplate 104 for affixing the modular forming tool 105 to the forming machine (not shown). In alternative embodiments, means of lifting the baseplate 104 other than baseplate lifting hooks 108 may be used. In alternative embodiments, means for connecting the baseplate 104 to a forming machine (not shown) other than the mounting slot 110 may be used. Forming surface lifting hooks 106 may be attached relative to the exchangeable forming component 101. In alternative embodiments, means of lifting the exchangeable forming component 101 other than forming surface lifting hooks 106 may be used.

Alternative embodiments of a modular forming tool may have an interface block and baseplate integrally formed with one another. It is also within the scope of the disclosure for an alternative modular forming tool to be devoid of a baseplate (for example, where the interface block is configured for direct, removable attachment to the forming machine). Furthermore, for certain aspects of the disclosure, the modular forming tool may be devoid of both an interface block and a base plate. For instance, embodiments of the exchangeable forming component and the forming machine may have complemental surfaces for direct, removable attachment between the exchangeable forming component and the forming machine.

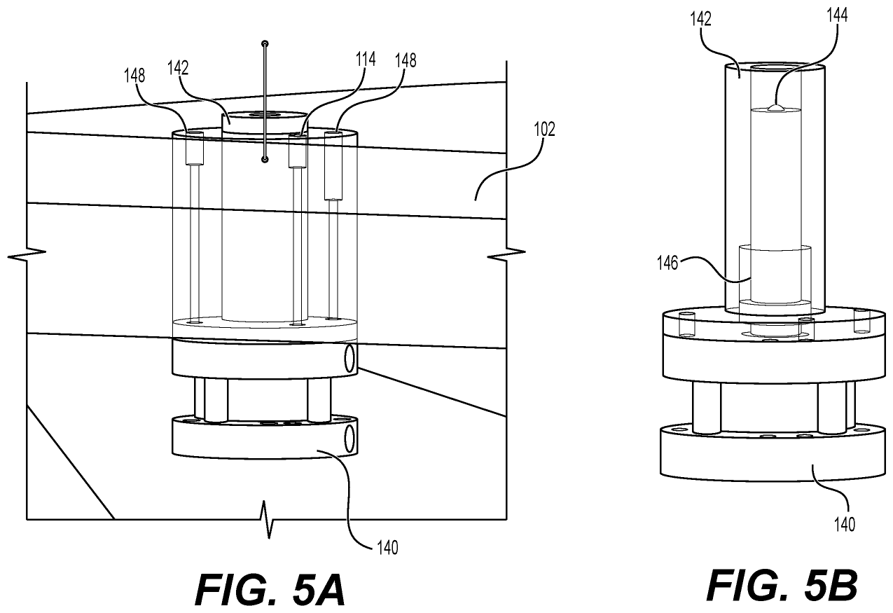

Embodiments of the exchangeable forming component 101 may define prick punch bore holes 114 in which prick punches 144 and pneumatic cylinders (see FIG. 5A and FIG. 5B) exist along the span of the EFS 102. That is, prick punches 144 may be operably located inside the bore holes 114. The bore holes 114 may intersect the EFS 102 of the exchangeable forming component 101. A prick punch pneumatic manifold 116 may be mounted to the vertical side surface of EFS 102. In other embodiments, prick punches 144 may be configured for punching holes in the sheet metal being formed.

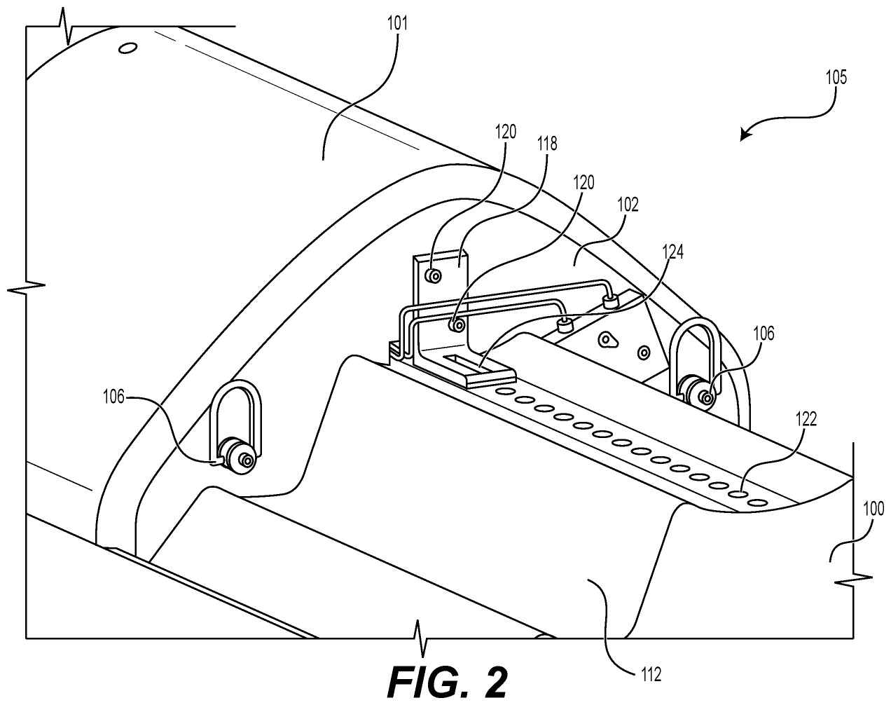

FIG. 2 shows the attachment bracket 118 removably attached to the exchangeable forming component 101 with bolts 120 inserted horizontally and perpendicular to the vertical surface of EFS 102. Threaded openings 122 are arranged along the flat horizontal surface of the interface block 100. A slot 124 may be defined in the horizontal portion of the attachment bracket 118 to accommodate vertical bolts (not shown). A vertical bolt may be extended through the slot 124 of attachment bracket 118 and threaded into a selected one of the threaded openings 122. In this manner, the exchangeable forming component 101 may be removably attached to the interface block 100.

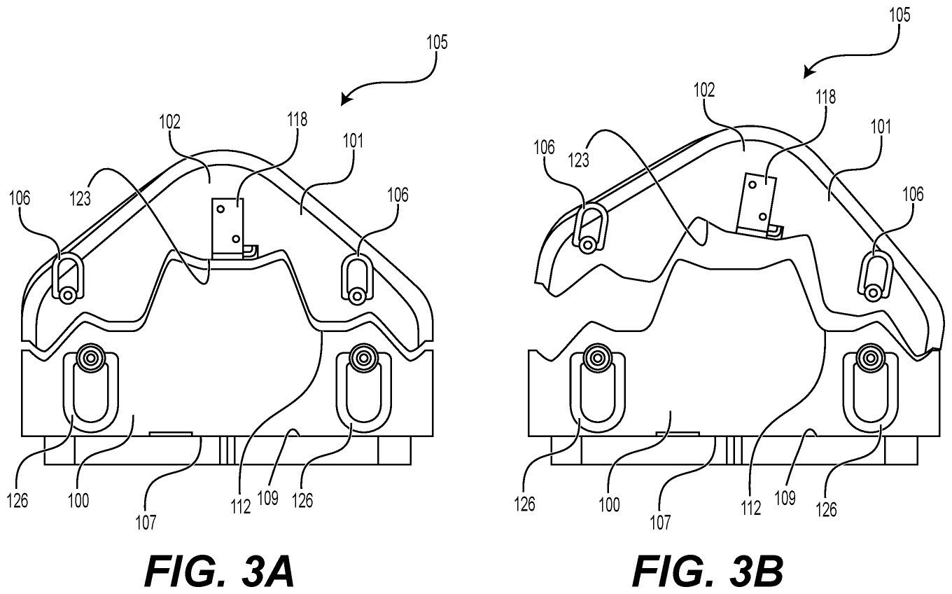

FIG. 3A and FIG. 3B demonstrate the complemental mating geometry of the self-aligning interface block mating surface 112 and the exchangeable forming component 101. FIG. 3A shows the mating of a component mating surface 123 of the exchangeable forming component 101 and the interface block mating surface 112 of the interface block 100 under normal circumstances. During the mating process, the exchangeable forming component 101 may be lowered vertically into engagement with the interface block 100 while the component mating surface 123 and the interface block mating surface 112 cooperatively align the interface block 100 and the exchangeable forming component 101 with one another. That is, the interface block mating surface 112 and the component mating surface 123 cooperate with each other to be self-aligning when mated together.

The configurations of the interface block mating surface 112 and the component mating surface 123 provide several favorable characteristics: 1) an even pressure distribution between the exchangeable forming component 101 and the interface block 100; 2) allows a range of exchangeable forming surface widths (dimensionally into the page as shown in FIG. 3A) to be operably received on one interface block 100; and, 3) eliminates the risk of jamming when loading and unloading the exchangeable forming component 101 relative to the interface block 100. An example of the potential jamming risk during mating can be seen in FIG. 3B. If the exchangeable forming component 101 is lowered at an uneven angle, the self-aligning configuration of the interface block mating surface 112 and component mating surface 123 may be restricted from becoming lodged or jammed during installation. In this example, the right side of the exchangeable forming component 101 contacts the interface block 100 first, while other portions of the exchangeable forming component 101 remain spaced from the interface block mating surface 112 of interface block 100. This lack of additional contact may restrict jamming of the interface block 100 and/or the exchangeable forming component 101. In this example, the operator may simply continue lowering the exchangeable forming component 101 onto the interface block 100 so that the two components may self-align. Finally, FIG. 3A and FIG. 3B show interface block lifting hooks 126 which protrude horizontally from the vertical surface of the interface block 100.

The exchangeable forming component 101 may be interchangeable with multiple additional forming components that are also exchangeable (that is, the additional forming components may be interchangeably used with the interface block 100). As noted, the exchangeable forming component 101 may present the component mating surface 123. Similarly, each of the additional exchangeable forming components has a respective alignment surface that is identical in shape to the component mating surface 123. Within the scope of the present disclosure, exchangeable forming components may have different sizes, different mating surface shapes, or both. The exchangeable forming components may all be compatible for mounting with the same interface block (such as interface block 100).

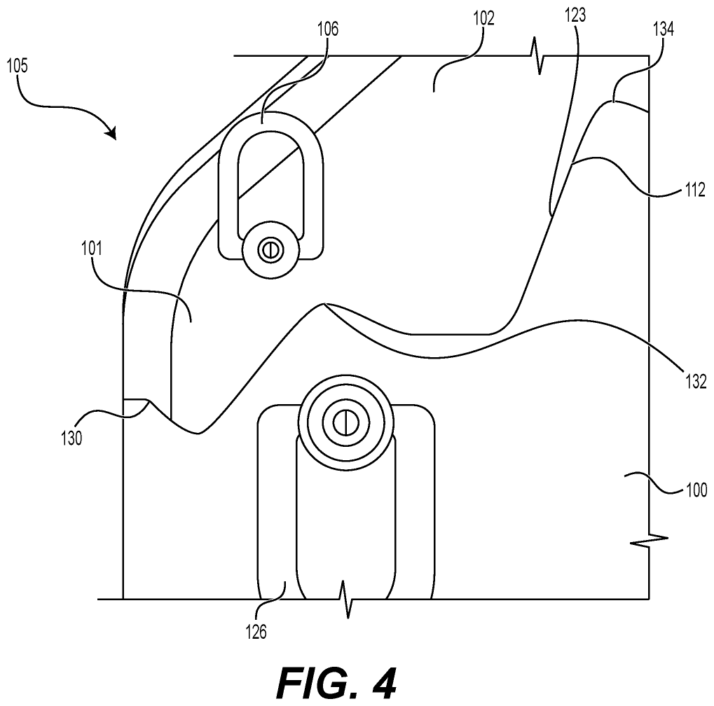

FIG. 4 further shows one half of the interface block mating surface 112 configured for favorable pressure distribution characteristics between EFS 102 and interface block 100. During the stretch form process there is significant pressure applied to the modular stretch block tool assembly. Raised securing elements 130, 132, and 134 may be defined by the interface block mating surface 112 at each corner. The raised securing elements 130, 132, and 134 may comprise ridges that extend longitudinally along the length of the interface block 100. The component mating surface 123 of the exchangeable forming component 101 may define channels that removably receive corresponding ones of the raised securing elements 130, 132, and 134. During normal loading conditions where a force is applied vertically to the modular forming tool 105, the raised securing elements 130, 132, and 134 provide lateral reaction forces which counteract any splitting forces and thereby restrict unfavorable deformation of the EFS 102.

FIG. 5A and FIG. 5B show the pneumatic prick punch system incorporated into the exchangeable forming component 101. An air piston 140 is mounted underneath the surface of the EFS 102 and secured by bolts (not shown) via counterbored bolt holes 148. A bushing 142 is incorporated into the prick punch bore holes 114. FIG. 5B further shows the bushing 142 which houses the prick punch 144. A return spring counterbore 146 exists within the bushing 142 to facilitate the return of the prick punch after pneumatic activation. The counterbored bolt holes 148, prick punch bore holes 114, and other mounting provisions for the air piston 140 and pneumatic prick punch system are machined into the exchangeable forming component 101 after the AM process.

The modular stretch block assembly constructed using AM techniques offers multiple benefits to aircraft and sheet metal manufactures: 1) By utilizing AM polymer construction, a reduction in mass is obtained compared to traditional metal casting, forging, or subtractive manufacturing techniques; 2) the reutilization of the interface block 100 for several different part configuration reduces cost and lead time for manufacturing; 3) by utilizing both AM and subtractive manufacturing, the EFS 102 can be printed (or otherwise formed) to a near-net state using additive manufacturing and machined (or otherwise modified) to the final state or configuration resulting in further reduction in cost and lead time; and, 4) existing pneumatic prick punch systems can be incorporated directly into the AM exchangeable polymer forming surface during 3D printing, further reducing complexity, cost, and lead time. Thus, the modular stretch block assembly using AM techniques is an improvement to the field of aircraft manufacturing, and sheet metal stretch-forming, and is worthy of patent protection.

Many different arrangements of the various components depicted, as well as components not shown, are possible without departing from the spirit and scope of what is claimed herein. Embodiments have been described with the intent to be illustrative rather than restrictive. Alternative embodiments will become apparent to those skilled in the art that do not depart from what is disclosed. A skilled artisan may develop alternative means of implementing the aforementioned improvements without departing from what is claimed.

It will be understood that certain features and subcombinations are of utility and may be employed without reference to other features and subcombinations and are contemplated within the scope of the claims. Not all steps listed in the various figures need be carried out in the specific order described.

The invention claimed is:

1. A modular forming tool configured for removable mounting relative to a support structure to form a sheet metal component, said modular forming tool comprising:
an exchangeable forming component which is constructed using additive manufacturing,
wherein the exchangeable forming component presents
a first surface which provides an exchangeable forming surface shaped to form the sheet metal component, and
a second surface configured to removably engage the support structure and align the exchangeable forming surface relative to the support structure.

2. The modular forming tool of claim 1, wherein the exchangeable forming component is 3D printed out of a polymer material.

3. The modular forming tool of claim 1, wherein the exchangeable forming component defines one or more bore holes intersecting the first surface; and
one or more prick punch systems operably located inside the one or more bore holes.

4. The modular forming tool of claim 3, wherein the one or more prick punch systems include a pneumatic prick punch for punching holes in the sheet metal component.

5. The modular forming tool of claim 1, further comprising:
an interface block configured to provide at least part of the support structure, wherein the interface block presents a third surface, for removable mating with the second surface of the exchangeable forming component, and a fourth surface; and
an attachment element for attaching the exchangeable forming component to the interface block, when the second surface is mated to the third surface.

6. The modular forming tool of claim 5, further comprising:
a baseplate configured to be affixed to a forming machine, wherein the baseplate presents
a fifth surface, for mating with the fourth surface of the interface block; and
a second attachment element for mounting the baseplate to interface block, when the fourth surface is mated with the fifth surface.

7. The modular forming tool of claim 6, wherein the exchangeable forming surface is 3D printed and made of a polymer material.

8. The modular forming tool of claim 6,
wherein the exchangeable forming component defines one or more bore holes intersecting the first surface; and
one or more prick punch systems operably located inside the one or more bore holes, for punching holes in the sheet metal component.

9. The modular forming tool of claim 6,
wherein the second surface and the third surface cooperate with each other to be self-aligning when mated together, such that:
the exchangeable forming surface and interface block are aligned with one another; and
deformation of the exchangeable forming surface during operation is restricted.

10. The modular forming tool of claim 9, further comprising:
a plurality of additional exchangeable forming components;
wherein each of the plurality of additional exchangeable forming components has a respective alignment surface which is identical in shape to the second surface of the exchangeable forming component;
wherein each of the respective alignment surfaces, of the plurality of additional exchangeable forming components, is compatible for mating with the third surface of the interface block.

11. The modular forming tool of claim 10, wherein the plurality of additional exchangeable forming components form a plurality of additional sheet metal component designs.

12. An exchangeable forming component configured for removable mounting relative to an interface block of a modular forming tool, with the interface block of the modular forming tool configured for removable mounting relative to a support structure to form a sheet metal component, said exchangeable forming component comprising:
a component structure which is constructed using additive manufacturing,
wherein the exchangeable forming component presents
a first surface which provides an exchangeable forming surface shaped to form the sheet metal component, and a second surface configured to removably engage the support structure.

13. The exchangeable forming component of claim 12, wherein the exchangeable forming component defines one or more bore holes intersecting the first surface; and one or more prick punch systems operably located inside the one or more bore holes.

14. A method of forming sheet metal components, the method comprising:
selecting a desired sheet metal component shape;
using additive manufacturing techniques to construct an exchangeable forming component presenting a first surface shaped according to the desired sheet metal component shape; and
stretch forming sheet metal over the first surface of the exchangeable forming component, such that one or more sheet metal components are formed in the desired sheet metal component shape.

15. The method of claim 14, wherein the additive manufacturing technique is 3D printing using polymer materials.

16. The method of claim 14, further comprising:
constructing the first surface of the exchangeable forming component to a near-net state using additive manufacturing; and
using subtractive manufacturing to modify the first surface of the exchangeable forming component from the near-net state to a final state.

17. The method of claim 16, the method further comprising:
mounting one or more prick punch systems inside one or more holes on the first surface;
using the one or more prick punch systems to punch one or more holes into the sheet metal components during stretch forming of the sheet metal.

18. The method of claim 14, further comprising:
assembling a modular forming tool, comprising:
mating a second surface of the exchangeable forming component with a third surface of an interface block,
mounting the exchangeable forming component to the interface block,
mating a fourth surface located on the interface block to a fifth surface located on a baseplate which is configured to be affixed to a forming machine, and
mounting the interface block to the baseplate;
affixing the baseplate to the forming machine; and
forming sheet metal over the first surface of the exchangeable forming component using the forming machine.

19. The method of claim 18, further comprising:
lowering the second surface of the exchangeable forming component onto the third surface of the interface block, such that the exchangeable forming component is aligned with the interface block.

20. The method of claim 19, further comprising:
constructing a plurality of exchangeable forming components having different sizes, surface shapes, or both, and which are all compatible for mounting with the interface block;
removing a first exchangeable forming component which forms a first sheet metal component;
selecting a second exchangeable forming component from among the plurality of exchangeable forming components for mating with the interface block;
forming a second sheet metal component with a different shape than the first sheet metal component.
